(19) United States
(12) Patent Application Publication
(10) Pub. No.: US 2003/0235338 A1
(43) Pub. Date: Dec. 25, 2003

(54) Transmission of independently compressed video objects over internet protocol

(75) Inventor: Thomas A. Dye, Austin, TX (US)

Correspondence Address: Jeffrey C. Hood, Meyertons, Hood, Kivlin, Kowert & Goetzel PC, P.O. Box 398, Austin, TX, 78767, US

(73) Assignee: Meetrix Corporation, Houston, TX

(21) Appl. No.: 10/446,407

(22) Filed: May 28, 2003

Related U.S. Application Data
(60) Provisional application No. 60/389,974, filed on Jun. 19, 2002.

(51) Int. Cl. G06T 9/00

(52) U.S. Cl. 382/232; 382/248; 382/243; 382/236

(57) ABSTRACT

A method and process for improving the quality of multi participant video conferencing over Internet Protocol. The method uses a unique grayscale area map that represents objects in 3-D space to determine area boundaries and object priority for culling prior to transport. The method uses an objects depth map to determine the highest energy magnitude for motion estimation and compensation. By controlling the flow rate of objects over the temporal domain and the re-creation of object based predictive frames, a constant bit-rate scalable video compression algorithm has been shown. Spatial and temporal hierarchical significance trees are used to build maps of significant energy on a per-object basis. Thus, the bit-rate of compressed video is dynamically adjusted by the limitation of data transport through the network.

### PRIORITY CLAIM

This application claims benefit of priority of U.S. provisional application Serial No. 60/389,974 titled “TRANSMISSION OF INDEPENDENTLY COMPRESSED VIDEO OBJECTS OVER INTERNET PROTOCOL” filed Jun. 19, 2002, whose inventor is Thomas A. Dye which is hereby incorporated by reference in its entirety.

### FIELD OF INVENTION

The present invention relates to video encoding and decoding system architectures, and more particularly to video telecommunications used for remote collaboration over IP networks. Embodiments of the invention contain novel technology for effective transport of audio and video over IP networks. Embodiments of the invention also compensate for the variance in latency and bandwidth in a packet based network protocol.

### DESCRIPTION OF THE RELATED ART

Since their introduction in the early 1980's, video conferencing systems have enabled users to communicate between remote sites, typically using telephone or circuit switched networks. Recently, technology and products to achieve the same over Internet Protocol (IP) have been attempted. Unlike the telephone networks, which are circuit switched networks with direct point to point connections between users, IP networks are packet switched networks. In a packet switched network, the information being transmitted over the medium is partitioned into packets, and each of the packets is transmitted independently over the medium. In many cases, packets in a transmission take different routes to their destination and arrive at different times, often out of order. In addition, the bandwidth of a packet switched network dynamically changes based on various factors in the network.

Many systems which attempt to perform video conferencing over IP networks have emerged in the marketplace. Currently, most IP-based systems produce low-frame-rate, low resolution and low quality video communications due to the nature of the unpredictable Internet connections. In general, Internet connections have been known to produce long latencies and to limit bandwidth. Therefore most video conferencing solutions have relied on dedicated switched networks such as T1/T3, ISDN or ATM. Theses systems have the disadvantage of higher cost and higher complexity. High costs are typically associated with expensive conferencing hardware and per minute charges associated with dedicated communications circuits.

Therefore, it is desirable to have a system that mitigates these costs, reduces transport complexities, improves video resolutions and frame-rates and runs over standard IP networks while maintaining full duplex real-time communications.

Designers and architects often experience problems associated with IP networks due to the lack of consistent data rates and predictable network latencies. The industry has developed communication technologies such as H.323 to smooth out some of the problems associated with video based conferencing solutions. For quality reasons the H.323 specification is typically used over ISDN, T1 or T3 switched networks. Systems which utilize H.323 are adequate for conference room audio and video collaboration, but require a higher consistent bandwidth. In current technology, these systems can be considered high bandwidth solutions.

According to Teliris Interactive in an April 2001 survey on videoconferencing, 70 percent of end users do not feel videoconferencing has been successful in their organizations. Also, 65 percent of end users have not been able to reduce travel as result of such video collaboration. In all cases, end users report that they require specific support staff to set up multiparty bridge calls. In addition, over half the users find it difficult to see and hear all participants in the video conference. In short, prior art technology has not delivered long distance audio, video and data collaboration in a user-friendly manner. Most end users resorted to the telephone to complete the communication when the video collaboration system failed to deliver. This becomes especially true when video and audio collaboration are conducted over non-dependable IP networks.

Traditionally, full duplex video communication has been accomplished using compression techniques that are based on discrete cosine transforms. Discrete cosine transforms have been used for years for lossy compression of media data. Motion video compression standards such as MPEG (ISO/IEC-11172), MPEG-2 (ISO/IEC-13818), and MPEG-4 (ISO/IEC-14496) use discrete cosine transforms to represent time domain data in the frequency domain. In the frequency domain, redundant or insignificant components of the image data can be isolated and removed from the data stream. Discrete cosine transforms (DCT) are inherently poor when dynamically reducing the bandwidth requirements on a frame by frame basis. DCT operations are better suited for a constant bandwidth pipe when real-time data transport is required. Most often, data reduction is accomplished through the process of quantization and encoding after the data has been converted to the frequency domain by the DCT operation. Because the MPEG standard is designed to operate on blocks in the image (typically 8×8 or 16×16 pixel blocks, called macro blocks), adjustments made to the transform coefficients can cause the reproduction of the image to look pixelated under low-bit-rate or inconsistent transport environments. These situations usually increase noise, resulting in lower signal to noise ratios between the original and decompressed video streams.

In addition, prior art systems are known to reduce spatial and temporal resolutions and color quantization levels, and reduce the number of intra-frames (I-Frames) to compensate for low-bit-rate throughput during channel transport. Changing spatial resolutions (typically display window size) does not readily allow dynamic bandwidth adjustment because the user window size cannot vary dynamically on a frame by frame basis. High color quantization or the reduction of intra-frames can be used to adjust bit-rates, typically at the expense of image quality. Temporal reductions, such as frame dropping, are common and often result in jittery video.

Thus, it is desired to encode data for transport where the bit-rate can be dynamically adjusted to maintain a constant value without substantial loss of image quality, resolution and frame rate. Such a system is desirable in order to compensate for network transport inconsistencies and deficiencies.

Recently, the use of discrete wavelet transforms (DWTs) has proven more effective in image quality reproduction. Wavelet technology has been used to deliver a more constant bit rate and predictable encoding and decoding structure for such low bit rate error-prone transports. However, the DWT has lagged behind MPEG solutions for low-bit-rate transport. Discrete wavelet transforms, when used for video compression, have numerous advantages over Discrete Cosine Transforms, especially when used in error prone environments such as IP networks. One advantage is that sub band filters used to implement wavelets operate on the whole image, resulting in fewer artifacts (reduced pixelation) than in block-coded images. Another advantage of sub band coding is the robustness under transmission or decoding of errors because errors may be masked by the information on other sub bands.

In addition to higher quality, discrete wavelet transforms have the added ability to decimate information dynamically during multi-frame transport. For example, two-dimensional wavelet transforms (2D-DWT) are made up of a number of independent sub bands. Each sub-band is independently transformed in the spatial domain, and for 3D-DWT, in the temporal domain to reduce the amount of information during compression. In order to reduce the information, spatial sub-bands are simply reduced in quantity. High frequency bands are reduced first and low frequency bands are reduced last. By the elimination of sub-band information during transport, discrete wavelet transforms can dynamically compensate for changes in the IP network environment.

Prior art systems have introduced the concept of three-dimensional discrete wavelet transforms. Three-dimensional DWTs not only use spatial information but also temporal information (between multiple video frames) to reduce the amount of energy during transport. By application of the DWT over a number of frames, high frequency information in the temporal domain can be sub-sampled as compared to low frequency information in the same temporal frame. For example, the human eye may not notice the difference between a video sequence of only high frequency components sent at 20 frames per second vs. the same set of components sent at 10 frames per second over the same time period. Put another way, out of 20 frames sent in one second, only 10 frames of high frequency temporal information may need to be sent to achieve the same video quality. One issue of temporal wavelet transformation has been the complexity of the calculations and cost of custom processors or application specific devices to produce such transforms in real time.

Therefore, it is desirable to have a wavelet based compression system that compensates for temporal redundancies commonly found in video data. It is further desirable that the system not be as computation intensive as 3-D wavelet transforms. Thus, one objective of some embodiments of the invention is to actively compensate for network inconsistencies during compressed video transport by altering the flow rate of independently compressed video objects and their associated sub-bands during transport over IP networks.

As noted above, image sub bands can be easily quantized for fixed bit-rate transport. Because sub bands can be summed together after inverse wavelet transformation, this method represents a way to control dynamic quality and bit rate variation. However, prior art systems have not adequately used wavelet transforms for the process of motion compensation and estimation. In other words, prior art systems have faced challenges when attempting to combine motion estimation with the use of wavelet transforms.

Motion estimation algorithms are typically based on blocks of pixels, typically either 8×8 or 16×16 pixels per block. However, wavelet transforms are inadequate when used in small blocks for conventional motion estimation. Wavelet transforms typically require the entire image be filtered into sub bands, not lending an easy methodology for blocks of pixels to be transformed. Thus, for application of wavelet transforms to compression of images, a full image is required to decompress the compressed image. One problem that arises is how to perform motion estimation based on a full image. Prior art systems have not been able to perform adequate motion compensation based compression in conjunction with wavelet transforms. Therefore, it is desirable to improve the quality of compressed images by the use of wavelet transforms and to estimate object motion without the loss in quality associated with block based motion estimation.

Recently, studies have shown the ability to use wavelets for temporal space over a group of frames to further compress data. Therefore, it would be desirable to have a methodology whereby wavelet transforms could be predictably applied to larger object areas, substantially reducing the task of motion vector calculations on separate blocks of pixels.

FIG. 1—Description of a Prior Art System

FIG. 1 shows a prior art system for video encoding and decoding using motion estimation, motion compensation and motion vector encoding along with both wavelet transform encoders and decoders. FIG. 1 shows an encoder on the left of the diagram, a decoder on the right of the diagram, and the transport medium 300 in the middle.

The encoding system shown at the left side of the transport medium 300 is made up of multiple components: the frame store 100, the discrete wavelet transform engine 150, encoder 250, predictive frame decoder 450, inverse discrete wavelet transform 550, motion estimation 140, motion vector encoding engine 130, motion compensation engine 110, and a differencing unit 120.

The encoder system is operable to generate a reference frame 115, a predictive frame 112, a difference frame 125, the transport media stream for I frames 265, the transport media stream for P frames 275 and the motion vector transport stream 285. Combined transport streams 265, 275, 285 are encapsulated within the IP protocol for transport across the transport medium 300 to the client decoder.

The client decoder shown on the right half of FIG. 1, decodes the information sent across the transport medium 300 with the following units: the decoding engine 450 the inverse discrete wavelet transform engine 550, the frame store 100, a frame summation unit 430, motion vector decoding unit 440, and motion compensation engine 110.

FIG. 1 is a representation of the prior art for encoding and decoding video images using discrete wavelet and inverse wavelet transformations for sending data across an Internet transport mechanism. In particular this prior art shows a wavelet transform being used in preparation for data compression and decompression. For the ability to compensate for limited bandwidth and network inconsistencies, wavelet transforms are preferred for controlling the quality of service during media transport over IP.

Referring to the prior art system of FIG. 1, the frame store unit 100 receives image data from a image capture device such as a camera digitizer. The frame store 100 unit is typically memory located in the computer system. The memory typically holds one or more video frames. The frame store 100 provides a frame of digital data to the discrete wavelet transform engine 150. The DWT engine 150 applies the discrete wavelet transform (DWT) in order to transform the image data into sub bands of information. The discrete wavelet transform engine 150 delivers multiple sub bands of filtered information to the encoding engine 250, where quantization is performed. The resulting quantized data from the encoding block 250 is then packetized according to the standard IP protocol for delivery over the transport medium 300 such as the Internet.

In addition, the quantized data produced by the encoder is sent to a decoding block 450 located within the local encoder. The decoding block 450 reverses the process of quantization. The decoding block 450 outputs the multiple sub bands of image data as close as possible to that previously input to the encoding block 250. The multiple sub bands of image data are then sent to the inverse discrete wavelet transform engine 550 for reassembly to a single reference frame 115. The reference frame 115 is the result of compression of the image followed by decompression and represents the reference frame that will be seen at the remote decoder.

As shown, the IDWT 550 of the encoder produces a reference frame 115 that is provided to motion compensation block 110. The motion compensation block 110 provides a predictive frame to differencing unit 120. The differencing unit 120 also receives a new frame (Fnew) 106 from the frame store 100. The differencing unit 120 outputs a difference frame 125 to the DWT block 150. The results of this differencing from the difference unit 120 is a difference frame 125, often referred to as a predictive or P-frame. Although this frame is actually a difference frame based on a predictive frame, prior art systems simply refer to this as a P-Frame. The difference frame 125 is highly compressible and is used as a reference between the information contained in the image of a new frame and that of the previously encoded frame. The difference frame 125 is then sent to the discrete wavelet transform engine 150 again for sub band filtering. FIG. 1 indicates intra frames (I frames) in solid black lines, while difference frame coding (P-frame coding) is indicated in dashed lines.

The motion estimation block 140 receives images from a frame store 100 and performs motion estimation to generate motion vectors 135. Motion vectors 135 are output to motion vector encoding block 130 for encoding into encoded motion vectors 285. The encoded motion vectors 285 are then transported over transport medium 300 to the remote video decoder.

Motion vectors 135 are also output from motion estimation block 140 to motion compensation block 110. The motion compensation block 110 also receives the reference frame 115 from IDWT block 550. The motion compensation block 110 reconstructs the predictive frame for use by the differencing unit 120 as described above.

As seen in FIG. 1, in the prior art, I frames are sent using a standard wavelet sub band encoding technique. Wavelet encoding is also used for predictive frames while predictive frames are sent along with motion vector information. Motion vectors and predictive frame coding significantly reduce the transport bandwidth required between a group of frames. Motion compensation and estimation are prior art techniques used to compress data in the temporal domain rather than in the spatial domain.

Again referring to FIG. 1, the decoder in the prior art system is now described. As shown, I frame information enters the decoder 450 for reverse quantization into multiple sub bands. The results from the decoder 450 are then input to the inverse discrete wavelet transform engine 550, where the multiple sub bands are combined back into the original I frame image. The output I-frame 105 is then sent to a temporary frame store 100 for display and further processing.

The motion vector decoding block 440 receives encoded motion vectors 285 over the transport medium 300. The motion vector decoding block 440 decodes the encoded motion vectors 285 and provides the decoded motion vectors to the motion compensation block 110. The motion compensation block 110 also receives a reconstructed frame 117 from the frame store. The motion compensation block 110 uses the reconstructed frame 117 and the decoded motion vectors to then output a predicted frame 114. Thus the motion compensation block 110 and motion vector decoding block 440 operate together to decode a predicted frame.

Once the I-frame has traversed the decoder and been stored in the frame buffer 100, the subsequent or following information to the decoder 450 is typically a series of predictive frames (P-frames). Encoded P-frames 275 are transported through the transport medium 300 to the decoding engine 450 where once again the quantized data is reversed quantized and presented as sub bands to the inverse discrete wavelet transform engine 550. The inverse discrete wavelet transform engine 550 in the decoder then transforms the sub band information into a single difference frame 127. This frame is summed by the summation unit 430 with the predicted frame from the motion compensation engine 110. The result is a reassembled frame of information which was constructed from predictive information and motion vector information, and this reassembled frame is sent to the frame store 100 for display. Motion vector decoding 440 reverses the process of the motion vector encoding block 130. Thus in the prior art system decoding of motion vectors is the process of restoring the original motion vector information 135 of the encoder motion estimation block 140.

### SUMMARY OF THE INVENTION

Various embodiments are described of a system and method for improved compression/decompression of video data. In some embodiments, the system provides improved performance where the transport medium has varying bandwidth, i.e., where the size of the transport pipe is dynamically growing and shrinking.

The system may include a camera system that acquires images to be transported over a transport medium. The camera system may include a first camera operating in the visible light range for acquiring an image of the scene, e.g., for acquiring an image comprising grayscale values or color values representing the image. The camera system may also include a second camera, preferably operating in a non-visible light range, for acquiring an image representing the 3D depth of objects in the scene.

In one embodiment, after the acquisition of image data from the camera system, the method operates to detect and classify objects in the acquired image. The method may operate on at least a subset of the objects, or on all of the detected objects. In one embodiment, objects are identified in the image based on their xy position in area and their depth from the camera (e.g., z distance from the camera). Objects in an image may comprise a person, a face, elements of a face (nose, eyes, ears, etc.), a table, a coffee mug, a background, or any other object that might be identifiable by a viewer.

In one embodiment, the system determines the depth information for each object. The system may utilize a non-visible light source, such as an infrared (IR) light source, that generates non visible EM radiation on to the scene. The reflected non visible light is received by an IR detector and used to determine the relative depths or Z distances of objects in the scene. The non-visible light source may provide both pulsed and continuous EM radiation onto the scene and use the reflected light to determine relative depths of the objects in the scene. The system may operate to generate a depth intensity image, i.e., an image where the pixel values represent the 3D depth of the scene, as opposed to the intensity (grayscale or color) of the image.

Each object may have associated object information. Object information may comprise object spatial information (e.g., xy location, size, etc.), depth information, and temporal changes over multiple frames. Each object may also be independently classified by priority encoding, wherein certain objects, e.g., foreground objects, are assigned a higher priority, and certain objects, e.g., background objects, are assigned a lower priority. Thus, objects may be assigned various video attributes. However, objects may comprise components other than video components.

Each object may then be compressed using wavelet transformations and priority quantization techniques. In one embodiment, objects are independently encoded using the discrete wavelet transform (DWT). Application of the DWT to a video object produces a number of sub bands containing components of the image. Objects may be compressed using sub band culling for network transmission.

For at least some frames, such as intra frames (I frames), the number of sub bands included in the encoded image object may be dynamically modified based on one or more of: 1) the relative priorities of the objects (e.g., based on relative depths of the objects), and 2) the available bandwidth in the transport medium.

Thus the objects may be independently compressed based on relative priorities of the objects. The relative priorities of the objects may be based on the relative depths of the objects within the scene, which may indicate whether objects are foreground or background objects. Foreground objects (objects that are considered “in-focus) are typically more important than background objects, and hence foreground objects are given a higher priority than background objects.

The objects may also be independently compressed based on the available bandwidth in the transport medium. In other words, when the transport medium bandwidth shrinks or is reduced, the method operates to dynamically cull or remove sub bands from certain compressed object images. When the transport medium bandwidth increases, more sub bands may remain in the encoded image. In one embodiment, the method operates to remove sub bands from lower priority objects first. At the decoding or decompression stage, the received sub bands can be summed together to reproduce the original image. Any degradation resulting from culling of sub bands in the encoded image is less noticeable to a user than quantization techniques used with discrete cosine transforms.

One embodiment of the invention also uses motion compensation techniques to compress respective image objects for generation of “predicted frames”. As described above, one problem with wavelet transforms used for compression of images is that a full image is required to decompress the compressed image. One problem that arises is how to perform motion estimation based on a full image. In one embodiment, motion vectors for the prediction of object movement are generated by a unique maximum thresholding algorithm to determine quickly the sum of absolute differences on a per object sub block basis. In addition the method may operate to quickly and easily obtain motion estimation values by a maximum energy thresholding technique used during the process of object identification and classification.

In one embodiment, motion vector estimation is performed on a per object basis. Each object may be broken down into a plurality of sub-blocks. The method may also iteratively compare different depth object image resolution maps or images, beginning with analysis of low resolution object images first, and proceeding to higher resolution images as necessary. A “tree hierarchy” subdivision method may be used to determine the most significant energy of each object. This method involves comparing “pixels” from a location in the object from a prior frame with “pixels” from a current frame to estimate the motion of the object. In one embodiment, the motion estimation method uses the depth map or depth image in the creation of motion vectors, i.e., compares “pixels” representing depth of the object from prior and current frames of the depth image. In an alternate embodiment, the motion estimation method uses the image of the scene (grayscale or color) in the creation of motion vectors.

The method may operate to determine significant and insignificant pixels present in each object, preferably based on values of the pixels. The motion estimation may then be performed using primarily or only significant pixels. The method first compares the highest order bit of “pixels” from prior and current frames of the depth image and determines if the highest order bits have changed. The method then compares the second highest order bits, and so on, thereby creating a “tree hierarchy” of comparisons. As the method traverses to the high resolution with more scene granularity while performing the comparisons. The resulting “tree hierarchy” provides information on whether an object has moved, and if so, where the object has moved to, relative to the prior frame. The “tree hierarchy” method essentially constructs a list of address pointers (address list) indicating where significant energy in the object has moved. A simple address compare can then be performed between the tree hierarchies in the current and prior frame to determine object motion. The combination of motion estimation using hierarchical trees along with an address compare method is considerably faster than prior art block based motion estimation techniques.

Once the method determines that the object has moved, the method may encode one or more motion vectors in the predicted frame indicating this motion. The method may also encode the differences among pixels in the object for transmission along with the motion vectors. If the method determines that the object has not moved (or moved very little), the method may encode a value indicating the decompression unit should use the sub bands for the object from the prior frame.

In one embodiment, objects receive a frame rate attribute based on level of importance in the scene. Thus objects may be transmitted at a plurality of varying rates based on their frame rate attribute. In other words, more important objects may be transmitted more often than less important objects. For example, in a video collaboration system, foreground objects, including the image object of the participant user, may be transmitted more frequently, such as every frame. On the other hand, background objects, such as the background or objects in the background, may be transmitted much less frequently.

Thus, by encoding objects independently and adjusting their transport flow rate to match the transport characteristics, information used for real-time media collaboration over IP networks can be controlled to a higher degree and quality can be improved significantly over other prior art techniques.

One embodiment of the invention dynamically compensates for a changing transport mechanism. One embodiment uses the DWT on 2D spatial areas of each frame on a per object basis over a specified range of depth planes.

In one embodiment, the system may comprise a video collaboration system wherein two or more users collaborate using video-conferencing techniques.

### BRIEF DESCRIPTION OF THE DRAWINGS

A better understanding of the present invention can be obtained when the following detailed description of the preferred embodiment is considered in conjunction with the following drawings, in which:

FIG. 1 illustrates a prior art system using wavelet compression technology;

FIG. 2 illustrates a network based video collaboration system according to one embodiment of the invention;

FIG. 3 is a high-level block diagram illustrating an embodiment of the present invention;

FIGS. 4A and 4B illustrate the use of an infrared sensor and radiation source for the determination of object depths;

FIG. 5 is a flowchart diagram illustrating determination of the object area depth and identity classification;

FIG. 6A illustrates a scene with typical objects of different depths;

FIG. 6B illustrates sub band encoding of the image in 6A;

FIG. 6C illustrates the area of interest located within FIG. 6A and 6B;

FIG. 7A represents illustration of the 3-D depth of objects into three separate scales;

FIG. 7B illustrates using split partitions in hierarchical trees for the determination of object positioning in space;

FIG. 8 illustrates the flow diagram for determination of object motion vectors; and

FIG. 9 illustrates the operation of differencing to achieve motion estimation between multiple lists of significant pixels.

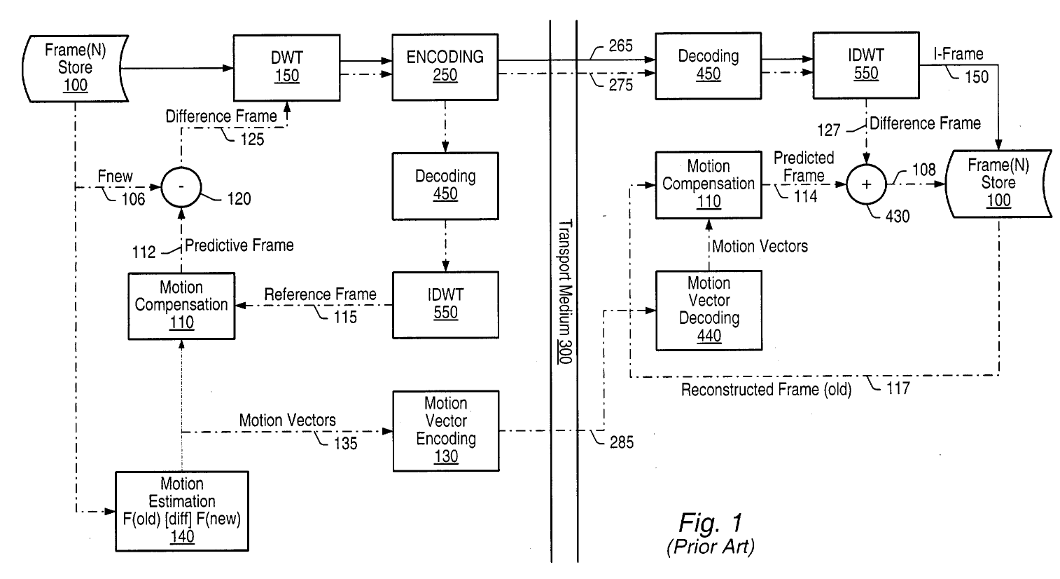

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENT

Various embodiments of a novel video communication system are disclosed. Embodiments of the video communication system employ improved compression and decompression techniques to greatly improved quality and reliability in the system.

One embodiment of the present invention includes a novel technique to sub segment objects both in spatial (2-D), Volumetric (3-D), and temporal domains using a unique depth sensing apparatus. These techniques operate to determine individual object boundaries in spatial format without significant computation.

Compressed image objects may then be transferred at varying rates and at varying resolution, and with varying amounts of compression, dependent on the relative depth of the object in the scene and/or the current amount (or predicted amount) of available bandwidth. For example, foreground objects can be transferred at a greater rate or greater resolution than background objects. Also, image objects may have a greater or lesser amount of compression applied dependent on their relative depth in the scene. Again, foreground objects can be compressed to a lesser degree than background objects, i.e., foreground objects can be compressed whereby they include a greater number of sub bands, and background objects can be compressed whereby they include a lesser number of sub bands.

One embodiment of the present invention also comprises using object boundaries for the decomposition of such objects into multiple 2-D sub bands using wavelet transforms. Further, hierarchical tree decomposition methods may be subsequently used for compression of relevant sub bands. Inverse wavelet transforms may then be used for the recomposition of individual objects that are subsequently layered by an object decoder in a priority fashion for final redisplay.

In addition, one embodiment of the present invention comprises using lists of significant and insignificant pixel addresses to replace the traditional block comparison methods used in prior art motion estimation computations. In one embodiment, individual object sub blocks and hierarchical spatial tree decomposition for the determination of object motion estimation and compensation build predictive frames.

In some embodiments, the techniques described herein allow for bit rate control and ease of implementation over the prior art. Embodiments of the present invention may also allow real-time full duplex videoconferencing over IP networks with built-in control for dynamic consistent bit-rate adjustments and quality of service control. Thus, at least some embodiments of the present invention allow for increased quality of service over standard Internet networks to that known in prior art techniques.

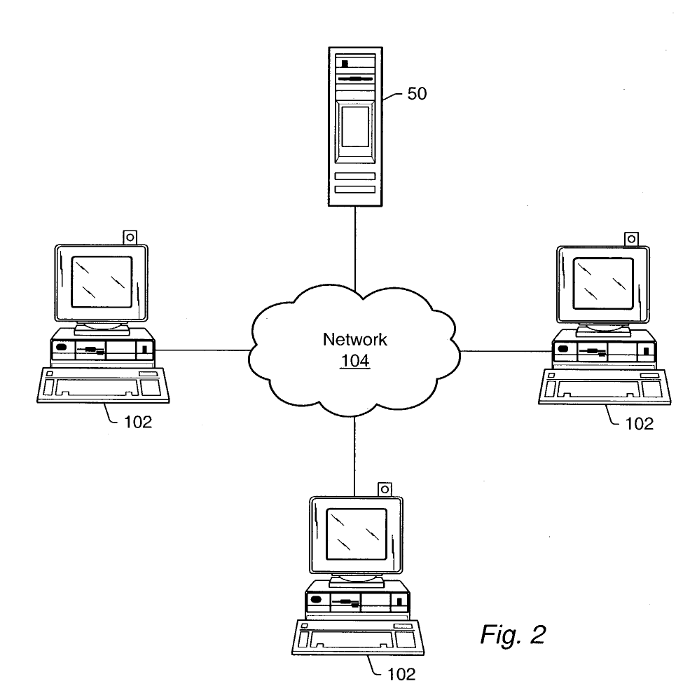

FIG. 2—Video Collaboration System

FIG. 2 illustrates a video collaboration system according to one embodiment of the invention. The video collaboration system of FIG. 2 is merely one example of a system which may use embodiments of the present invention. Embodiments of the present invention may also be used in digital video cameras, such as movie cameras for personal or professional use. In general, embodiments of the present invention may be used in any system which involves transmission of a video sequence comprising video images.

As shown in FIG. 2, a video collaboration system may comprise a plurality of client stations 102 that are interconnected by a transport medium or network 104. FIG. 2 illustrates 3 client stations 102 interconnected by the transport medium 104. However, the system may include 2 or more client stations 102. For example, the video collaboration system may comprise 3 or more client stations 102, wherein each of the client stations 102 is operable to receive audio/video data from the other client stations 102. In one embodiment, a central server 50 may be used to control initialization and authorization of a single or a plethora of collaboration sessions.

In the currently preferred embodiment, the system uses a peer-to-peer methodology. However, a client/server model may also be used, where, for example, video and audio data from each client station are transported through a central server for distribution to other ones of the client stations 102.

In one embodiment, the client stations 102 may provide feedback to each other regarding available or predicted network bandwidth and latency. This feedback information may be used by the respective encoders in the client stations 102 to compensate for the transport deficiencies across the Internet cloud 104.

As used herein, the term “transport medium” is intended to include any of various types of networks or communication mediums. For example, the “transport medium” may comprise a network. The network may be any of various types of networks, including one or more local area networks (LANs); one or more wide area networks (WANs), including the Internet; the public switched telephone network (PSTN); and other types of networks, and configurations thereof. In one embodiment, the transport medium is a packet switched network, such as the Internet, which may have dynamically varying bandwidths and latencies.

The client stations 102 may comprise computer systems or other similar devices, e.g., PDAs, televisions. The client stations 102 may also comprise image acquisition devices, such as a camera. In one embodiment, the client stations 102 each further comprise a non-visible light source and non-visible light detector for determining depths of objects in a scene.

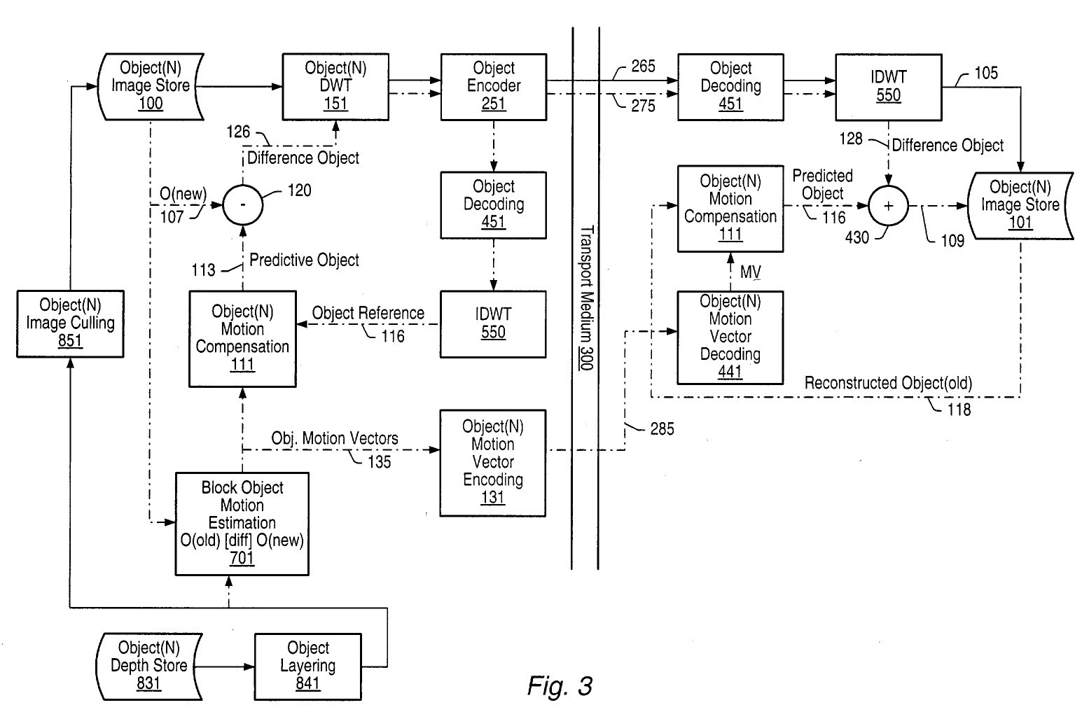

FIG. 3—Block Diagram of Video Encoding and Decoding Subsystems

FIG. 3 is a block diagram of one embodiment of a system. FIG. 3 illustrates a video encoding subsystem to the left of transport medium 300, and a video decoding subsystem to the right of the transport medium 300. The video encoding subsystem at the left of the transport medium 300 (left hand side of FIG. 3) may perform encoding of image objects for transport. The video decoding subsystem at the right of the transport medium 300 (right hand side of FIG. 3) may perform decompression and assembly of video objects for presentation on a display.

It is understood that a typical system will include a video encoding subsystem and a video decoding subsystem at each end (or side) of the transport medium 300, thus allowing for bi-directional communication. However, for ease of illustration, FIG. 3 illustrates a video encoding subsystem to the left of the transport medium 300 and a video decoding subsystem to the right of the transport medium 300.

In FIG. 3, each of the encoder and decoder subsystems are shown with two paths. One path (shown with solid lines) is for the intra frame (I-frame) encoding and decoding and the other path (shown with dashed lines) is for predictive frame encoding and decoding.

The system may operate as follows. First, an image may be provided to the video encoding subsystem. The image may be provided by a camera, such as in the video collaboration system of FIG. 2. For example, a user may have a camera positioned proximate to a computer, which generates video (a sequence of images) of the user for a video collaboration application. Alternatively, the image may be a stored image. The captured image may initially be stored in a memory (not shown) that is coupled to the object depth store queue 831. Alternatively, the captured image may initially be stored in the memory 100.

In one embodiment, the video encoding system includes a camera for capturing an image of the scene in the visible light spectrum (e.g., a standard gray scale or color image). The video encoding system may also include components for obtaining a “depth image” of the scene, i.e., an image where the pixel values represent depths of the objects in the scene. The generation of this depth image may be performed using a non-visible light source and detector. The depth image may also be generated using image processing software applied to the captured image in the visible light spectrum.

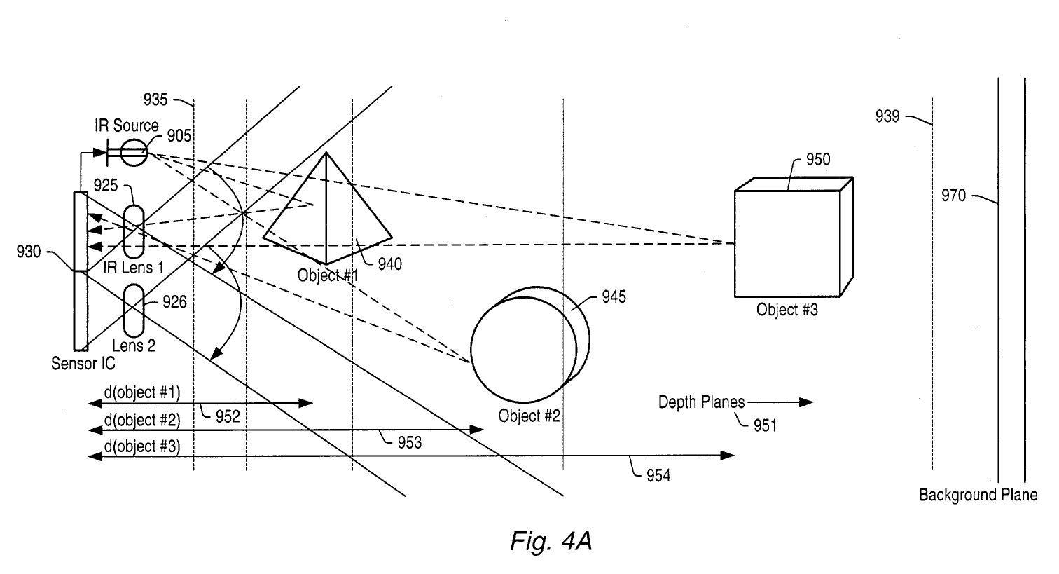

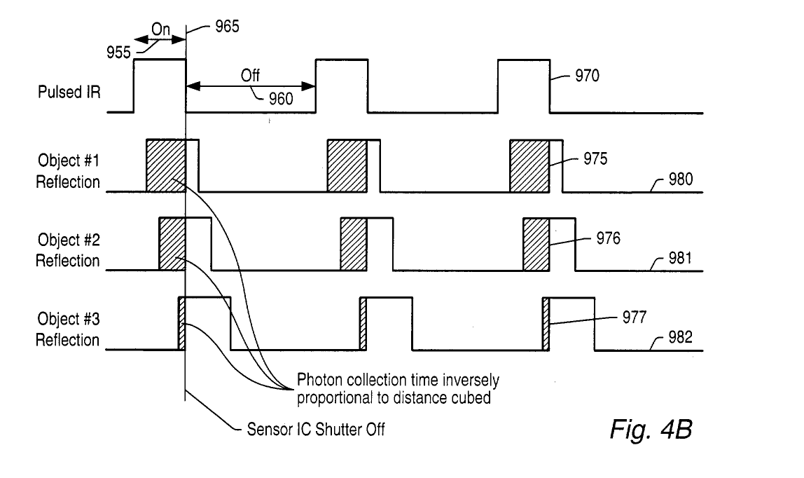

A plurality of image objects may be identified in the image. For example, image objects may be recognized by a depth plane analysis, as described in FIGS. 4A and 4B below. In other words, in determining the 3-D space of the objects in the image, in one embodiment the methodology described in FIGS. 4A and 4B is used to determine the object depths and area positions. These depth and position values are stored in a depth store queue 831. Thus the image may be recognized in 3-D space. The object depth and position values may be provided from the depth store queue 831 as input to the object-layering block 841.

In one embodiment, all of the detectable image objects may be identified and processed as described herein. In another embodiment, certain of the detected objects may not be processed (or ignored) during some frames, or during most or all frames.

The object-layering block 841 references objects in the depth planes and may operate to tag objects in the depth planes and normalize the objects. The object-layering block 841 performs the process of object identification based on the 3D depth information obtained by the depth planes. Object identification comprises classification of an object or multiple objects into a range of depth planes on a “per-image or frame” basis. Thus, the output of the object layering method 841 is a series of object priority tags which estimate the span of the object(s) in the depth space (Z dimension). Object-layering 841 preferably normalizes the data values such that a “gray-scale” map comprising all the objects from a single or multiple averaged frame capture(s) have been adjusted for proper depth map representation. In addition, object identification may include an identity classification of the relative importance of the object to the scene. The importance of the various objects may be classified by the respective object's relative position to the camera in depth space, or by determination of motion rate of the respective object via feedback from the block object motion estimation block 701. Thus object-layering is used to normalize data values, clean up non-important artifacts of the depth value collection process and to determine layered representations of the objects identifying object relevance for further priority encoding. Thus, the object-layering block 841 provides prioritized & layered objects which are output to both the object motion estimation block 701 and the object image culling block 851.

The object image-culling block 851 is responsible for determining the spatial area of the 2-D image required by each object. The object image-culling block 851 may also assign a block grid to each object. The object image-culling block 851 operates to cull (remove) objects, i.e., to “cut” objects out of other objects. For example, the object image culling block 851 may operate to “cut” or “remove” foreground objects from the background. The background with foreground objects removed may be considered a background object. Once the object image-culling block 851 culls objects, the respective image objects are stored individually in the object image store 100. Thus the object image store 100 in one embodiment may store only objects in the image. In another embodiment, the object image store 100 stores both the entire image as well as respective objects culled from the image.

Thus, for an image which includes a background, a single user participating in the collaboration, a table, and a coffee mug, the object image block 841 and the object image culling block 851 may operate to identify and segregate each of the single user, the table, the coffee mug and the background as image objects.

The encoding subsystem may include control logic (not shown) which includes pointers that point to memory locations which contain each of the culled objects. The object image store 100 may store information associated with each object for registration of the objects on the display both in X/Y area and depth layering priority order. Object information (also called registration information) may include one or more of: object ID, object depth information, object priority (which may be based on object depth), and object spatial block boundaries, (e.g., the X/Y location and area of the object). Object information for each object may also include other information.

The following describes the compression of I frames (intra frames) (the solid lines of FIG. 3). I frames may be created for objects based on relative object priority, i.e., objects with higher priority may have I frames created and transmitted more often than objects with lower priority. In order to create the first intra frame, the object (which may have the highest priority) is sent to the object discrete wavelet transform block 151. The object DWT block 151 applies the DWT to an image object. Application of the DWT to an image object breaks the image object up into various sub bands, called “object sub bands”. The object sub bands are then delivered to the object encoder block 251.

In one embodiment, the object encoder block 251 uses various hierarchical quantization techniques to determine how to compress the sub bands to eliminate redundant low energy data and how to prioritize each of the object sub bands for transport within the transport medium 300. The method may compress the object sub bands (e.g., cull or remove object sub bands) based on the priority of the object and/or the currently available bandwidth.

The object encoder 251 generates packets 265 of Internet protocol (IP) data containing compressed intra frame object data and provides these packets across the transport medium 300. Object sub-bands are thus encoded into packets and sent through the transport medium 300. In the current embodiment the output packets 265 of compressed intra frame data are actually compressed individualized objects. Thus frames of compressed objects (e.g., I frames) are independently transmitted across the transmission medium 300. Compressed objects may be transmitted at varying rates, i.e., the compressed image object of the user may be sent more frequently than a compressed image object of the coffee mug. Similarly, the compressed image object of the user may be sent at a higher resolution than a compressed image object of the coffee mug. Therefore, in one aspect of the object compression, intra frame encoding techniques are used to compress the object sub bands that contain (when decoded) a representation of the original object.

As described further below, in the decoding process object sub-bands are summed together to re-represent the final object. The final object may then be layered with other objects on the display to re-create the image. Each individualized object packet contains enough information to be reconstructed as an object. During the decoding process, each object is layered onto the display by the object decoder shown in the right half of FIG. 2.

Thus, in one embodiment the encoder subsystem encodes a background object and typically multiple foreground objects as individual I-frame images. The encoded background object and multiple foreground objects are then sent over the transport medium 300 for assembly at the client decoder.

Again referring to FIG. 3, the intra frame (I frame) object decoding process is described. For each transmitted object, the intra frame object is first decoded by the object decoder 451. The object decoder 451 may use inverse quantization methods to determine the original sub band information for a respective individual object. Sub bands for the original objects are then input to the inverse discrete wavelet transform engine 550, which then converts the sub bands into a single object for display. The object 105 is then sent to the decoder's object image store 101 for further processing prior to full frame display. The above process may be performed for each of the plurality of foreground objects and the background object, possibly at varying rates as mentioned above.

The received objects are decoded and used to reconstruct a full intra frame. For intra frame encoding and decoding, at least one embodiment of the present invention reduces the number of bits required by selectively reducing sub bands in various objects. In addition, layered objects which are lower priority need not be sent with every new frame that is reconstructed. Rather, lower priority objects may be transmitted every few frames, or on an as-needed basis. Thus, higher priority objects may be transmitted more often and with more information than lower priority objects. Therefore, when decoded objects are being layered on the screen, a highest priority foreground object may be decoded and presented on the screen each frame, while, for some frames, lesser priority foreground objects or the one or more background objects that are layered on the screen may be objects that were received one or more frames previously.

The following describes the compression of predicted frames (P frames) (the dashed lines of FIG. 3). In one embodiment, predicted frames are constructed using motion vectors to represent movement of objects in the image relative to the respective object's position in prior (or possibly subsequent) intra frames or reconstructed reference frames. Predicted frames take advantage of the temporal redundancy of video images and are used to reduce the bit rate during transport. The bit rate reduction may be accomplished by using a differencing mechanism between the previous intra frame and reconstructed predictive frames. As noted above, predicted frames 275 reduce the amount of data needed for transport.

The system may operate to compute object motion vectors, i.e., motion vectors that indicate movement of an object from one image to a subsequent image. In one embodiment, 3-D depth and areas of objects are used for the determination and the creation of motion vectors used in creating predicted frames. In other words, motion vectors may be computed from the 3-D depth image, as described further below. Motion vectors are preferably computed on a per object basis. Each object may be partitioned into sub blocks, and motion vectors may be calculated for each of these sub blocks. Motion vectors may be calculated using motion estimation techniques applied to the 3-D depth image. The motion estimation may use a “least squares” metric, or other metric.

FIG. 3 illustrates one embodiment of how predictive frames can be constructed. As shown, the object layering block 841 provides an output to the block object motion estimation unit 701. In one embodiment, the block object motion estimation unit 701 uses a unique partitioning tree at different temporal resolutions for a fast evaluation during the comparison process and building of motion vectors 135.

In the construction of predictive frames, one embodiment of the invention uses several novel features, including the derivation of motion compensation information, and the application of depth and area attributes of individual objects to predictive coding. In one embodiment, a difference object 126 is built using the difference of an object reference 116 and a predictive object generated by the object motion compensation block 111. Block motion estimation for object layering is covered in detail later in this disclosure.

To determine the object reference 116, the local object under consideration for transport may be locally decoded. This inverse transform is preferably identical to the process used at the remote client decoder.

Again referring to FIG. 3 an image object that is to be predictively encoded (a particular predictive object 126 from a plurality of objects) is provided from the object image store 100 to the object DWT block 151. The discrete wavelet transform block 151 performs a discrete wavelet transform on the individual object. In one embodiment the output of the transform block 151 is a series of sub bands with the spatial resolution (or bounding box) of the individual object. In alternate embodiments the object bounds may be defined by an object mask plane or a series of polygonal vectors. The object encoder 251 receives the sub bands from the DWT block 151 and performs quantization on the respective predictive object. The quantization reduces the redundant and low energy information. The object encoder 251 of FIG. 3 is responsible for transport packetization of the object in preparation for transport across the transport medium 300. Thus, in one embodiment a unique encoder is used for the construction, compression and transport of predictive frames in the form of multiple sub bands across the transport medium.

In the decoding process, the motion compensation block 111 essentially uses the object motion vectors plus the reference object and then moves the blocks of the reference object accordingly to predict where the object is being moved. For example, consider an object, such as a coffee cup, where the coffee cup has been identified in 3D space. The coffee cup has relative offsets so it can be moved freely in 3D space. The object is also comprised of sub blocks of volume that have motion vectors that predict movement of the coffee cup, e.g., that it is going to deform and/or move to a new location. One can think of small “cubes” in the object with vectors that indicate movement of the respective cubes in the object, and hence represent a different appearance and/or location of the coffee mug. The object motion compensation block 111 receives the motion vectors from the block object motion estimation unit 701, and receives the previous object reference (how the object appeared last time) from the IDWT unit 550. The object motion compensation block 111 outputs a predictive object. The predictive object is subtracted from the new object to produce a difference object. The difference object again goes through a wavelet transform, and at least a subset of the resulting sub bands are encoded and then provided as a predictive object.

The decoder subsystem decodes a predictively encoded object as follows. After the remote (or local decoder) client receives the predictively encoded object, the object decoding block 451 performs inverse quantization on the object. Once the decoding block 451 restores the quantized information, the predictive object is transformed by the inverse discrete wavelet transform engine 550. The discrete wavelet transform engine 550 converts the objects sub bands back to a single predictive object 128, which is used with the accompanying object motion vectors to complete decompression of the predictive object.

In order to transform the predictive object back to its original form, the decoder subsystem further operates as follows. The decoder includes an object motion vector decoding block 441 which receives encoded motion vectors 285 over the transport medium 300. The object motion vector decoding block 441 decodes the objects encoded motion vectors and provides the decoded motion vectors to a motion compensation engine (object motion compensation block) 111. The motion compensation engine 111 reads the previous object (reconstructed object) 118 from the object image store 101 and the object motion vector information from the motion vector decoding block 441 and outputs a predicted object 116 to a summation block. The previous object and the object motion vector information establish a reference for the summation 430 of the currently decoded predictive object 116 with the difference object 128. The predicted object 116 and the difference object 128 are summed by the summation unit 430 to produce a decoded object 109. Thus the output of the summation unit 430 represents the decoded object 109. The decoded object 109, along with positioning information, priorities and control information, is sent to the object image store 101 for further processing and layering to the client display.

Therefore, in order to decode a stream of predictive objects, the remote decoding client receives object motion vectors 285 across the transport medium 300. The object motion vector decoding block 441 converts these into a reasonable construction of the original motion vectors. These motion vectors are then input to the object motion compensation block 111 and subsequently processed with the previous object retrieved from the object image store 101, rebuilding the new object for the display.

FIGS. 4A and 4B—Determination of Object Depth Information

In one embodiment, the system operates to determine the depth of objects contained within the scene of the image being compressed. Depth information is used to determine object priority for transport. In video conferencing and collaboration for example, objects close to the camera are higher priority than background objects. Object motion alone in a 2D space may not be useable to determine the proper object boundaries for object culling and priority identification. The resulting depth information may be used in generating motion vector, as well as in determining relative priorities of objects being independently transported. The depth information may be calculated any number of ways. In one embodiment, the method determines depth information using image processing techniques as described in U.S. Pat. Nos. 6,219,461 and 6,269,197. In another embodiment, the method uses a non-visible light source and detector to aid in determining depths of objects. This embodiment is described below.

The nature of the human eye sensitivity to light is well-known. Natural sunlight contains the entire spectrum, but the eye cannot see frequencies above a certain level. It is well-known in the art that infrared radiation cannot be seen by the human eye, but can be detected by image sensing devices. For example, manufacturers of cameras using image sensors typically include special chemical filters over the photo collecting diodes in order to block out radiation the eye does not see. Such radiation can become a nuisance and blur quality pictures.

In one embodiment, non-visible EM radiation, such as IR radiation, is used to determine the depth of objects in the scene being viewed by the camera. The system thus operates to radiate light which is invisible to the human eye on the scene, and analyze the reflected non-visible light, for the purpose of determining object depths in the scene. In one embodiment, the system also uses a unique method whereby non-visible EM radiation is used for the determination of object areas and distances from the image sensor. This method thus contemplates the use of such radiation in the determination of object boundaries and priorities during the process of video image capture and transport through Internet networks.

FIG. 4A illustrates one embodiment of a system including an IR source 905, a sensor 930, which captures non-visible and visible EM radiation, and two lenses 925 and 926. The system preferably uses non-visible light for object depth detection. In the embodiment shown in FIG. 4A, the system uses infrared (IR) light, although other types of non-visible (or visible) light may be used. In the embodiment shown, one lens 925 is used for IR detection (non-visible EM radiation detection), while a second lens 926 is used for detecting the image (visible EM radiation detection). In another embodiment, the system includes only a single lens, wherein the single lens is operable to detect both visible and non-visible light, and the color and IR filters are mechanically or chemically shuttered.

The IR source 905 generates infrared radiation (IR) onto a scene. The IR sensor 930 receives the reflected light that “bounces off” of objects in the scene. The reflected light can then be analyzed to determine depths of the objects, positions of the objects, areas of the objects, and other information. In the example of FIG. 4A, the scene includes three objects 940, 945, and 950. The three objects 940, 945, and 950 have corresponding respective object distances 952, 953, 954.

In one embodiment, the system uses the round trip travel time of the non-visible light to determine depths of the objects. The system may also compensate for objects that have reflectivity. The system preferably uses a constant energy radiation source and a pulsed energy radiation source. In one embodiment, a single non-visible EM radiation source operates as both the constant energy radiation source and the pulsed energy radiation source. The non-visible light source may be turned on (without pulsing) during a first time period and may be pulsed during a second time period. For example, the non-visible light source may have the following pattern: pulse, pulse, pulse, pulse, pulse, radiate, pulse, pulse, pulse, pulse, pulse, radiate, etc.

When the non-visible light source generates constant energy (non-pulsing) light, the radiation sensitivity is proportional to one over the distance squared. If the non-visible light source is pulsed to “pulse” the energy on to objects in the scene, the radiation intensity collected is proportional to one over the distance cubed. These two mathematical formulas can be used to determine the object's real depth in the depth planes independent of its reflectivity.

FIG. 4B illustrates how electrical pulses applied to the IR source 905 in a specified pattern of pulses can be used to determine certain object distances 952, 953, 954. FIG. 4B depicts a pulsed IR source where the “on” time 955 of the pulse IR is significantly shorter than the “off” time 960. Again referring to FIG. 4B, the reflection of pulses bouncing off object1 980 can be seen to lag the source pulsed radiation 970. The lag between source pulse ‘on’ 955 and the received reflected pulse 975 helps to determine the distance of the object from the IR sensor 930. The shaded region 975 of object1 940 indicates the amount of energy and the time delay of that energy which is inversely proportional to the distance 952. Thus, energy reflected to/from object1 per pulse 970 is indicated by the shaded region 975. Likewise for object2 945 the pulsed radiation received at the image sensor array 930 shown in 981 has a longer lag time with a shorter pulse width 976 to the pulsed IR off time. Here the collected energy per pulse 976 is less because the distance of object2 945 is further from the source. Object3 982 reflection receives much less energy 977 at the IR sensor 930 due to the delay of the reflection coming from the IR source 905 bouncing off the object 950. For each pulsed IR source 970 the sensor integrated circuit 930 has either a mechanical or electronic shutter used to stop reflected IR energy flow at the end of each IR source 905 pulse. In one embodiment the far depth plane 939 is out of range of the radiated source and therefore is considered to be the background plane or background object. The system preferably determines when objects have different surface reflections. Therefore, both pulsed energy 970 and continuous radiated energy are used to determine actual object distances. These distances are then further processed to create a gray scale image indicating distances of objects by different levels of intensity.

As noted above, it can be shown that the photon collection time on the image sensor 930 is inversely proportional to the distance between the sensor and the object raised to the third power. For continuous radiation, the photon collection time is inversely proportional to the distance squared. The actual distance between the sensor IC lens and the object is then approximately the collected intensity of a continuous radiated source divided by the collected intensity of a pulsed radiated source. Thus the present embodiment uses both pulsed radiation and constant continuous radiation to determine the true object depth, resulting in improved object classification.

In FIG. 4B, the IR source 905 is pulsed, with the radiation having an on time 955, an off time 960, and a shutter time 965. The image sensor 930 may include a shutter 965 for stopping collection of IR data. As the IR source 905 is pulsed, since the radiation collected is inversely proportional to the distance cubed, close objects such as shown in 980 will result in more energy before the shutter shuts down, and objects such as object3 950, because of its distance, will result in less energy collected before the shutter shuts down. If the received IR data is viewed as a picture, the data may be represented as gray scale values, which tell not only the area of the object but also how close it is to the IR sensor. This information is used to determine in 3D space where objects reside within a scene. For example, this information can be used to determine a table of depths for each object in the scene.

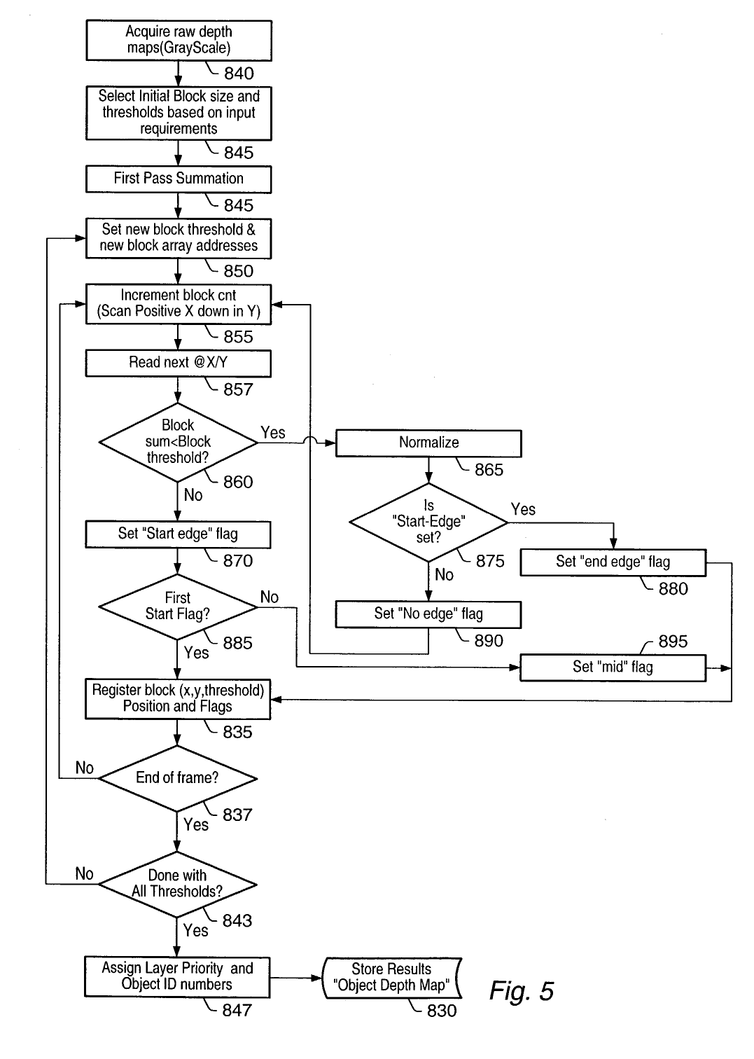

FIG. 5—Flowchart Diagram

FIG. 5 is a flowchart diagram illustrating determination of object areas, their depth thresholds and finally identity classification. The flowchart shown in FIG. 5 describes a method to determine objects that lie within different depth planes. Each depth plane has a different depth threshold value used for object classification in the XY plane. In addition, in one embodiment, each image is divided into multiple blocks 16 pixels by 16 pixels in area. In alternate embodiments, block size may vary depending on calculation complexity and scene quality. Software can very quickly scan the average value of a block and compare the value to existing thresholds to determine the depth and priority values for independent objects.

As shown, in step 840 the image sensor acquires depth information on objects present in the scene. In the current embodiment, this information comprises 255 levels of gray scale, and in alternate embodiments can be assigned other ranges. Raw depths are received in the infrared frequency spectrum as IR light is reflected or “bounced off” of various objects in the scene. The raw depth maps obtained in step 840 have information that may be redundant or misleading during further development of depth plane calculations.

In step 845 the depth information contained in the raw maps may be filtered and initial block size and thresholds may be determined. Thus, in step 845 the method sets the initial block size, block thresholds and storage memory for array allocation. The term “threshold” is used as a measure of the point at which the depth of the scene passes through a particular plane boundary. For example, the end of the first depth plane 935 as shown in FIG. 4A would represent the lowest threshold value, while the last depth plane 939 would represent the largest threshold or the “most black” threshold value for the scene.

Once the initial block size and thresholds are set, in step 847 each of the blocks in the array are summed and averaged, producing a result per block. In one embodiment a block is represented by 16 pixels on each side. In the present embodiment, only one value is output and stored for each block in step 847. Other embodiments may use a different number of pixels per block.

In step 850 the method sets a new block threshold. The new block threshold is used to compare against the averaged stored block value. Each new threshold represents a new depth plane boundary. Starting with the furthest depth plane, a threshold is developed to segment objects from the background image. As the threshold values are increased, depth comparisons are made for objects closer to the front depth plane 935.

In step 855 the block address preferably is incremented in the positive X direction. Thus, the IR sensor scan is performed in the positive x direction and down in the Y direction. When all blocks in the X direction have been detected, then in step 857 the address is incremented once in the Y direction for each new row of blocks. After step 855, in step 857 the value in the next selected block is read and in step 860 is compared to the threshold value. If the value read from the active block is less than the set threshold, it can be assumed that the object is behind or further back then the threshold being tested against.

If the summed value is determined to be greater than the threshold in 860, operation proceeds to step 870. In step 870, it is assumed that an edge of the object has been found. Thus, in 870 the start edge flag is set.

In step 885 a comparison is made to see if the edge of the object is the first edge of a block in a new object. If true, process continues to block 835. If the detected edge of the object is not the first or starting block of an object, the method continues to step 895.

In step 895 a mid-flag is set, indicating the “inner” space of an object. The mid-flag can be interpreted by the method as a block that exists in the middle of the object and not on either side near the exterior.

If the method has identified an object greater than the threshold in step 860, and the start flag has been set indicating that the object has first been recognized, in 835 the information and XY position of the object are registered for future usage. In addition to the position and flags, other information such as object ID and priorities may be set at this time.

If the block summed value is less than the block threshold in step 860, in step 865 a normalization step is performed. In one embodiment to simplify the object bounding box, a normalization process may set all values of the object to the most significant value. This allows the creation of an “alpha” mask which indicates the area of object interest, which in one embodiment is the depth value of the block closest to the lens and IR source.

In step 875 a start edge flag is tested. If the start edge flag is set, this indicates that the object has come to an end of that particular threshold. If the start edge flag is determined to be set in step 875, then in step 880 the end flag is set. The end flag indicates that the object has come to an end of that particular threshold. The process then continues with step 835 storing the registered values positions and flags.

If in step 875 a start edge flag is not set, this indicates that there is not a new edge of an object for this particular threshold of values. Thus, in step 890 the no edge flag is set and the method returns to 855. In step 855 a block address is incremented to select the next block for comparison.

After registration of the information such as positions, flags and priorities indicated in step 835, the method continues to 837 where a test for “all blocks have been completed” or “end of frame” is performed. If all blocks are not completed, the process continues back to step 855, and the next block is selected and prepared for test. The step continues until step 837 has completed. After an end of frame is determined in step 837, in step 843 a determination is made as to whether the method is finished with all thresholds. In step 843 the method determines if all the depth threshold values have been tested.

If all the depth plane threshold comparisons have not been completed as determined in step 843, then the method returns to step 850 where a new threshold is set and testing begins again. If all thresholds have tested 843, the method proceeds to step 847 where stored registered values are assigned layers, priorities, object names and ID numbers. Once layers have been assigned in step 847 the method stores these layers and results to the object depth maps in step 830.

In summary, FIG. 5 describes the process of determining object boundaries in the XY area plane as well as object boundaries in the depth plane (Z-plane). The method examines the depth information according to determined thresholds or z-depth layers, and determines the depth information of each object based on these layers.

In an alternate embodiment, a method using a hierarchy of tree decomposition is used to determine characteristics of objects. Object areas and depth planes can be determined with higher resolution by using the hierarchy of tree decomposition method as taught in this disclosure. In this embodiment, lower resolution spatial maps can be used for fast object edge detection. To further define object edges and further differentiate object depth bounds, higher resolution depth maps may be used to further refine object classification.

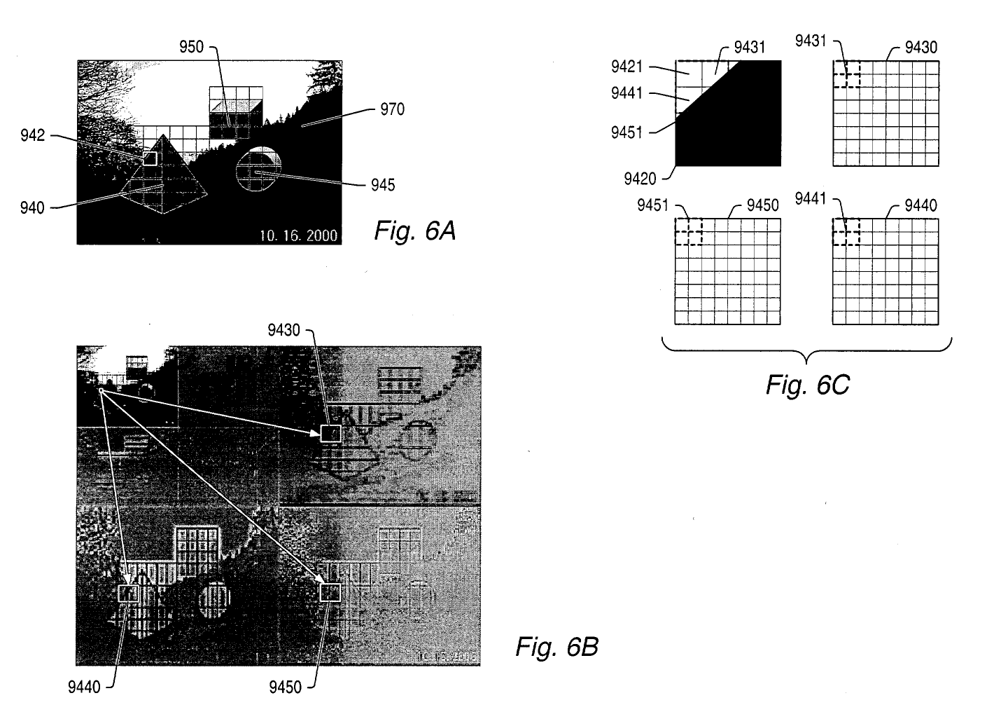

FIGS. 6A-6C

FIGS. 6A-6C describe method used in embodiments of the invention.

The example of FIGS. 6A-6C is described where the compression procedure is performed on the entire image. However, in the preferred embodiment, the compression method described below for the entire image may actually be performed for each individual object. Thus, in the preferred embodiment, the methods described with respect to FIGS. 6A-6C and applied to the entire image may in actuality be applied to each individual object within the image. The method is described here for an entire image for simplicity.

FIG. 6A represents a typical image example containing a background object 970 and three foreground objects 940, 945, 950. Information regarding each of these 4 objects may be transported through the transport medium in a compressed fashion as described herein.

Each of the objects may be broken down into a plurality of blocks. FIG. 6A shows a single block 942 on the grid of the pyramid object 940. This single block 942 is used to illustrate the process of object recognition and depth determination for each block of pixels on each object as represented in FIGS. 6B and 6C.

FIG. 6B shows the results after discrete wavelet transformation of the spatial image. Six sub bands with references to correlate the XY area between each sub band are illustrated. Of the six spatial sub bands transformed by the wavelet operation, the uppermost left image represents the base image after scaling and low pass filtering. A single block 942 is isolated, re-scaled and displayed in FIG. 6B. Three areas of a higher resolution map 9440, 9450, 9430 illustrate the other larger wavelet transformed subbands. FIG. 6B represents the background object intra frame used after compression steps and is used to remove redundant information during the quantization steps. In one embodiment, the method uses the three-dimensional object information to process only the sub bands necessary for each object to be transported after compression.

Thus the method may first determine the energy significance of one of the sub blocks within an object by performing a discrete wavelet transform on the object to build sub bands. This would produce a grid of sub bands in FIG. 6B (not shown). FIG. 6B illustrates an example of the output of the wavelet transform engine, which includes a base image from a low pass filter and then a combination of high pass and low pass bands. The wavelet transform quantization operates to reduce a large amount of repetitive energy in the image objects. After the inverse transform is applied at the remote decoder, these bands are summed back together to produce the final image.

FIG. 6B is only an example of what may happen with the background object, but not the individual objects. For exemplary purposes, FIG. 6B shows a representation of a complete frame to illustrate operation of the wavelet transform. Although not shown in FIG. 6B, in actuality object1 would be transformed into its own bands. Thus, although FIG. 6B shows operation for an entire frame, in the preferred embodiment the operation would occur on a per object basis. For example, on a per object, FIGS. 6B and 6C would relate to only a single image object, such as the triangle 940 in FIG. 6, and the background would just be black.

FIG. 6C indicates the correlation between the image pixels (shown in 6A and 6B) used for object predictive frames and the depth pixels used to determine the motion estimation of the object image pixels. In the preferred embodiment, motion vectors are calculated from depth maps using hierarchical trees, which are transported to the decoder along with object image sub bands (shown in 6A and 6B), and are used to predict the direction of motion.

As shown in FIG. 6C, intensity information may be determined by a hierarchical tree method. FIG. 6C represents the same pixel block of sub pixels and the edge of object 940 with internal pixel blocks are sub pixel blocks 9421, 9431, 9441, 9451. The sub pixel blocks also contain reference blocks to an address of similar locations located within the object grid. For example, FIG. 6C shows three reference subbands relating to the same pixel addresses shown in 9420 having been expanded to higher resolution subbands shown in 9450, 9440 and 9430 of FIG. 6B. Note that FIG. 6C correlates to the sub bands of the selected block of FIG. 6B for the selected block 942 in question of FIG. 6A. In an alternate embodiment, this process can continue for multiple sets of sub bands of different resolutions. In one embodiment FIG. 6B shows seven subbands. In alternate embodiments, additional sub bands may be processed for higher quality image representation.

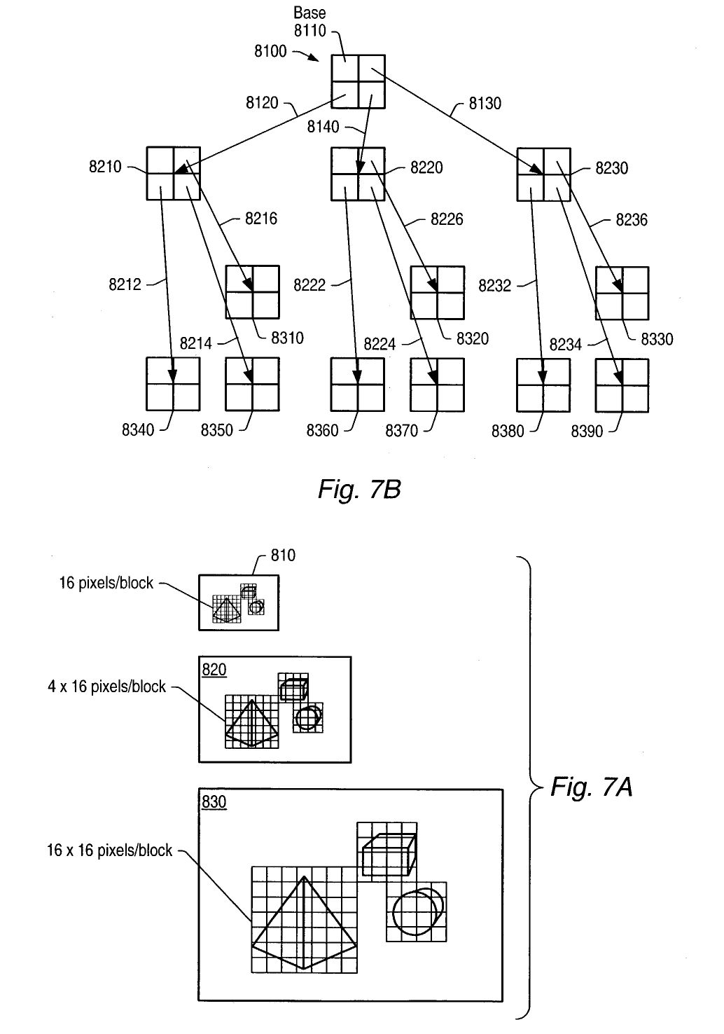

Thus, the method may comprise the steps outlined in the flowchart of FIG. 5, whereby each object has depth information and has been segmented into an array of subsequent blocks. Each object than can be transformed using wavelet transform operations independently from one another. Higher priority objects may be filtered for wavelet subbands independently of other objects which are possibly lower priority sub bands. A hierarchy of tree subdivision method shown in FIG. 6C may be used to determine the most significant energy of each object for purposes of motion vector computation. A more detailed description of the tree subdivision is depicted in FIG. 7.

The method uses hierarchical trees to determine high energy level in an object, (or in an entire image of multiple objects as shown in this example).

Given the small reference sub block 942 on this object 940, the object is transformed by wavelet transforms into sub bands. That reference point can be addressed in other higher resolution sub bands using a scaling function. The method may perform an algorithm of hierarchical trees to determine whether or not the pixels of that particular block have significance or insignificance. Presume the object has a large amount of gray scales from 0 to 255 in intensities, e.g., low to high, where the gray scale value for a pixel indicates relative depth, and the XY position references the block location. Brighter gray scale values indicate “closer” and dimmer gray scale values indicate further away. The method can then determine that for the object there are levels of high energy or high intensity and levels of low intensity. Here the method may not be concerned about the depth within the object because of the normalization filter used to create the depth maps of FIG. 5. In the present embodiment, the term “energy” is used to identify objects that are relevant to the scene, whereby higher energy objects are those close to the camera or those that are independent objects that move freely with respect to other objects.

If 8 bits are used, and the most significant bit is set for a respective pixel, then that pixel is a significant contribution to the “energy” of that particular pixel. The method can build lists of significant pixels and lists of insignificant pixels. An insignificant pixel is one which the magnitude bit would not be set in the first pass, e.g., for an 8-bit pixel the intensity value is 0 to 127.

In general, the eye sees intensity, where intensity in the depth map represents objects close to the camera or objects that have temporal energy components due to object motion over a given time frame. Thus the method prioritizes the most significant intensity values. Where the most significant bit is set, the method may then examine the next significant bit (for intensity values between 128-255) and segregate those. When the method examines the next bit, the method uses the next higher map, which is a bigger area. In the preferred embodiment, the highest level of detailed depth map is stored and decimated to lower resolution maps for testing of the most significant energy bits. In alternate embodiments, the depth maps may also be transformed using the DWT engine and used for determination of significance to build hierarchical trees.

The method can scale pixels among the different resolution maps by looking at the number of significant bits. In one embodiment, the method examines only 2 or 3 resolutional maps corresponding to the 2 or 3 most significant bits. A high quality application could utilize 5 or 6 resolutional maps corresponding to the 5 or 6 most significant bits. Each time the method examines another intensity level, it advances to a higher resolution map or sub band.

When a higher map is used, the method can begin to look at all the pixels for significance. The method can build another list of significant pixels and another list of insignificant pixels. The method then goes to the next resolution and uses the insignificant pixel addresses to examine those blocks. Thus the method uses a tree structure in finding the “hot spots” (high intensity of the image object) and the “cold spots” (low intensity of the image object). The method operates to determine the “hot spots”, since these are what should be transported. This is illustrated in FIG. 6C.

Consider a sub block of an object A. In many instances the area of this object A will actually be all zeros in a background object because it is not in the background object, it has already been culled out. The area for this object A in the background object has already been set to black in the grid so there will be no significance in that at all. However, as the method analyzes more pixels, significant pixels will be determined, i.e., the pixels will start to have information in them. Consider the 4 block pixels—9421, 9441, 9451 and 9431 of FIG. 6C, and examine them for significance; pixel 9421 has no significance. The value of 9441 may or may not, probably not because it is less area. So these 3 would be insignificant. The addresses for those 3 would go on to a list of insignificant pixels. Pixel 9451 has significance. Thus pixel 9451 goes to a list of significant energy. The list of significant energy pixels is really a list of addresses that points to that pixel's XY address in alternate resolution maps. Then what happens is the list of insignificance goes to the next resolution which is represented by pixels 9450, 9440 and 9430 like the 3 sub bands shown in FIG. 6B. Pixel 9451 is actually 4 pixels in a higher map but it represents the map say 9441 for insignificance. The next group of pixels are examined and the method determines which of these are significant or insignificant. Thus the method constructs another level of lists.

The rectangles in FIG. 6C represent pixels in a resolutional map that is being decimated. As noted above, the method examines various resolution images beginning with a lowest resolution image and examining the most significant bit in the pixel values, and proceeding to lesser significant bits, and so on. By the time the method examines the least significant bit, the method is examining a full resolutional map. The different resolutional images may be referred to as layers. If the method examines 3 layers, this involves examining the most significant bit and the next 2 significant bits of the object depth map. The method also adjusts the maps accordingly in resolution scale for each new layer examined.

Thus the method may examine a very low resolution map to determine that the block represented by this pixel in the low resolution map is of interest. The method may then break down this block into higher resolution maps. The method may proceed to a certain degree of desired resolution.

If the method examines a low resolution map and determines that everything is insignificant, the method may then examine the next higher resolution depth map. The next resolution depth map may contain a plurality of pixels, e.g., 4 pixels, for each pixel in the low resolution map. The method may converge and find significant pixels right away, or the method may have to traverse through successively higher resolution depth maps until significant pixels are found. This method is applied for motion vector estimation to produce the resolutional depth bands, and in one embodiment is performed on a per object basis.

FIG. 6 builds the compressed intra frame object image using hierarchical trees. In other words, the hierarchical trees method may be used to determine pixels or areas of significant energy and areas of insignificant energy. This information may then be used in determining which sub bands of the DWT are to be culled or removed for compression, i.e., pixels or areas of insignificant energy are culled first. FIG. 7 shows how the object depth maps and the same hierarchical tree methodology is used to build the motion vectors. FIG. 7 describes a method for predicting where the blocks in objects are going to move. For example, if the object itself is deformable or malleable, (like a piece of clay), and the object is deformed in some way, the sub blocks within that object may get moved in successive frames. The method operates to use the lists of significant pixels to determine the movement of objects, and portions of objects, between multiple frames.

For example, in calculating a motion vector, one method is to use the list of significant pixels and difference (subtract) the addresses of the list of the latest or current object frame's significant pixels from the address list of significant pixels from the last object frame. This novel action will zero in on the correct motion vector very quickly, without having to perform a large amount of convolutional calculations, as in prior art motion compensation algorithms. If the initial examination indicates insignificant pixels, the method may proceed to the next level. Thus the motion vector gets created very quickly. As noted above, the creation of motion vectors in MPEG is the most costly compute intensive operation being performed. The methodology of calculating the motion vector described herein is both simple and computationally efficient.

The grid in FIG. 6C represents the depth of the object in gray scale intensity. In an alternate embodiment, an offset exists from the origin of the frame to the origin of the grid. If that object actually moved laterally and did not rotate in space, the method could simply move the object. The method could simply transmit this reference to the grid, and the decoder method can move that object laterally based on the transmitted grid reference.

FIGS. 7A and 7B—Hierarchy of Tree Subdivision

FIGS. 7A and 7B of the present embodiment describes a method of using a “hierarchy of trees” for the creation of lists of significant and insignificant pixels representing the magnitude of object intensities over multiple resolutional depth maps. These lists play a major part in determining the motion estimation of sub blocks within defined objects. Motion estimation has proven to be a valuable component in the processing of low bit rate video transport.

Embodiments of the invention operate to simplify the compute requirements for motion estimation. To those skilled in the art, motion estimation is the most complex portion of video compression. Complexity results from the multiple comparisons of a block of pixels to multiple blocks of pixels in a surrounding area. In order to create motion vectors which project a block of pixels to the next frame time, in systems of the prior art, a motion estimation engine 140 must compare blocks of pixels from a prior frame and difference those pixels over a subjective area with the current frame. This process is very compute intensive and is typically the bottleneck in real-time video compression techniques. Embodiments of the invention operate to greatly reduce the amount of time and computation required for determining motion vectors.

FIG. 7A shows three depth maps of various resolutions. FIG. 7A shows the scaling of the depth maps in preparation for motion estimation calculations. FIG. 7B shows the creation of a set of lists of significant and insignificant depth pixels used to determine object energy within different sub bands based on a collection of such depth maps. These significant or insignificant depth pixel lists can be used for motion compensation and the final determination of motion vectors.

Embodiments of the invention may operate to separate objects quickly and determine the motion of each individual object in the temporal space domain. The embodiment shown in FIG. 7A comprises three depth maps of different scales. The method to determine object motion starts with the smallest resolution map 810. In one embodiment of the hierarchy of trees algorithm for determination of object motion, processing starts with the lowest resolution map 810, then proceeds to the next largest 820 and then the next largest after that 830, and so-on. This process continues based on the quality requirements and resolution required for object motion estimation. As shown in FIG. 7A, each resolution step may be increased in resolution. In alternate embodiments more or less resolution steps or more or less resolution scale factors may be used to optimize the motion estimation operation.

A group of lists are built to determine the most significant energy portions in specific spatial areas in the image plane. In some cases the most significant energy portions can be located in the first bit (most significant). When the intensity map for object depth does not contain energies of the most significant bit value, the offspring from the previous parent tree are used in conjunction with the next higher resolution image to once again determine the energy level at the next bit within the field. For example, an 8-bit grayscale image will compare the highest order bit of the eight bits using a less detailed map 810 while the next most significant bit (bit seven for example) will be used for magnitude comparison in the next higher resolution map 820. Once again, if that comparison did not show sufficient magnitude, another LISDP contributions will force another set of offspring and a higher resolution map 830 to be studied with the next most significant bit (bit 6 for example) of the 8-bit depth scale word. This process continues as lists of significant and insignificant pixels are built over the entire object. In the preferred embodiment, for each of a plurality of resolution depth maps the number of corresponding pixels scales to four. In alternate embodiments the scale factors may change based on various sample areas or other criteria such as the are of DWT transformation. Thus, the results of the multiple magnitude comparisons of different resolutions using a parent offspring hierarchy tree results in the ability to quickly determine a set of lists which can be used for temporal comparisons to estimate object motion.

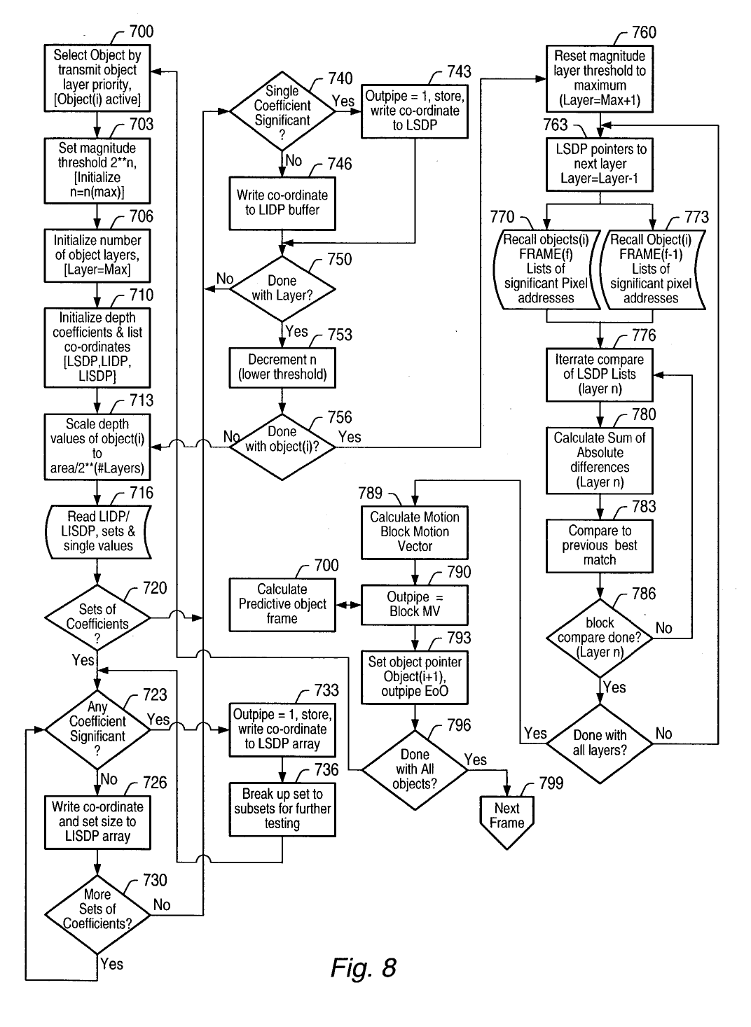

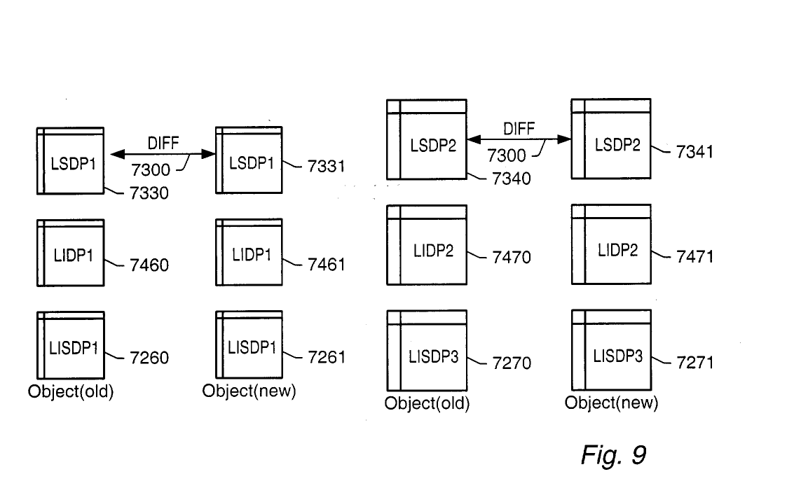

FIG. 7B shows the process of sub segmentation using trees to determine the most significant amounts of energy present within the detailed maps shown in 7A. Now referring to the details of FIG. 7B, the base set of four pixels located in block 8100 comprises a base pixel 8110 which correlates by XY address to the block indicated in low resolution map 810. The base pixel 8110 will be tested for a most significant contribution. This process entails determining if the most significant bit m is set. If the most significant bit m (magnitude bit) is set, no further determination or subdivision to higher resolution depth maps may be necessary. If the result of comparison at the base pixel 8110 does not contain a set magnitude bit, the four pixel group 8100 will be further split and compared with information from the next resolution map 820 and tested for an m−1 significant bit contribution. If such contribution exists, the address of that block of pixels is sent to a list of significant depth pixels (LSDP) for the second-order resolution 820. If no energy is present in the m−1 significant bit (most−1 significant bit of the average block of pixels) then process continues by first indicating that pixel group in a list of insignificant depth pixels (LIDP) and the process moves to the next higher resolution block 830 for further process. As seen in FIG. 7B after determination of the base pixel 8110 having no significant contribution it would then be added to the bottom of the LIDP as an address pointer to a block of pixels in the next higher resolution depth map. Each of the addresses for the three remaining pixels of the next resolution object map 820 represent another group of three sub blocks 8210, 8220, 8230 where a base pixel of each of these sub blocks is once again tested for significant contribution. In this case because of the second level of resolution the most significant bit minus 1 (m−1) is tested for significance. If the test is true the address of the sub block is registered in an LSDP. If the test shows depth pixels to be insignificant in the base pixel of three sub pixel groups 8210, 8220 and 8230 than a further subdivision and test may be carried out as shown in the bottom two rows of FIG. 7B. In such a case a higher resolution map 830 is used to read the depth values from addresses the correlates from the previous depth map 820. Here the group 8210 from the depth map 820 is used to point to three subgroups 8310, 8340 and 8350 of the higher resolution map 830. These three groups are again compared for significant contributions and lists are augmented for this level. The same process is carried out for example as 8220 is separated to three groups of sub pixels 8310, 8340, and 8350. The same process is carried out again for subgroup 8230, which is split into three other subgroups 8320 8360 and 8370 read from the higher resolution depth map 830. The same process is carried out again when 8230 is split out into 8330, 8380, and 8390. The process repeats up to a portion of significance and quality required for generation of the motion estimation vectors as described in further detail in FIGS. 8 and FIG. 9. Thus FIG. 7B represents a method and process for the subdivision and testing of significant energy located on a per object basis.

It is noted that FIGS. 7A and 7B depict full frame resolution, i.e., FIGS. 7A and 7B described the method as being applied to an entire frame. However, in a preferred embodiment of the present invention, the analysis is performed on a per object basis. This information and a plurality of lists that are built are used for comparison over a temporal set of frames containing a plurality of objects to determine object block transitions and subsequently to calculate motion vectors. The motion vectors in the preferred embodiment are used to estimate and predict object movement on a block by block, object by object basis. Thus, one novel aspect of this embodiment is the use of sub bands and “hierarchy of trees” to determine object movement, which significantly reduces the calculations required for motion compensation and motion estimation as known in prior art.

FIG. 8

An embodiment of the current invention lists significant pixels in multiple resolution maps which are used for the differencing operation. FIG. 8 is a flowchart illustrating both the building of the lists of significant pixels and the use of lists to quickly and easily determine motion estimation and subsequently derive motion vectors used for predictive coding.

Referring to FIG. 8, assume in step 700 a single object is received, wherein the object has a relative priority to other objects. The object has relative offset to its current position in the frame. Individual blocks of pixels hold the data that indicate the object's depth plane in the image. In the preferred embodiment, a 255 level grayscale is used to determine the object's relative depth from the video camera device. In alternate embodiments, other levels may be used to save compute time or to increase resolution. Once a single object has been selected for motion estimation determination, the magnitude is initialized. The magnitude thresholds in the preferred embodiment are powers of two, such that each layer (n) squares the magnitude of the depth value for each pixel. For example, layer 7 (n=7) represents 0-127 in magnitude, layer 8 would then represent 1-255 in magnitude. Initializing the magnitude begins with setting the layer to the maximum magnitude. For example, given a depth value of 255, the most significant bit of the eight bits has the highest magnitude and thus is initialized in this case to eight. 703 indicates the variable “Max” as the value for the number of layers to be examined. In the preferred embodiment, the number of layers is 4, although the number of layers may typically be set to two or three.

In 706 the number of layers then is set to Max, preferably 4.

In 710 the depth coefficients read from the stored high-resolution map are initialized and positioning of the LSDP and LIDP is chosen for the selected object.

In 713 the method performs a preprocessing of the high-resolution object depth map to produce a number of multi-resolution maps based on the nMax value previously selected. In 713 the method selects the scaled object map for each layer of the process. Thus, up to this point, an object has been selected, the significant and insignificant lists have been qualified, the high-resolution object map containing depth values has been scaled to the minimum resolution, and process begins with the maximum layer.

In 716 the object lists of insignificant isolated depth pixels and sets of significant isolated depth pixels are read for processing. At this point in 716, it should be noted that during the first base comparison, the LIDPs are set to all locations. In one embodiment, to begin the process the initial lists are set to “sets” of insignificant depth pixels (lists of insignificant sets of depth pixels—LISDP). Sets of values are important because they can be used from previous hierarchy trees of the object for areas where no significant depth pixels exist or had existed during prior comparisons. Thus, sets of pixels may yield more efficient tree comparisons.

In 720 a comparison is made for a selected set of coefficients that are pointed to by a list of addresses previously initialized within the LISDP.

If the “sets of coefficients” is true, meaning that a set must be processed, the process continues to 723. In 723 a determination of the maximum thresholds contribution is tested. This test comprises checking the most significant bit of each coefficient. If the test indicates the significant bit is set in 723, the process flow continues to 733. In 733 an update occurs, which involves writing the coordinates of the significant pixel into the LSDP array. For coding efficiency of the algorithm and for real-time transmission of data, in the preferred embodiment, the outpipe is set to one, because of an understanding of a sequential addressing mechanism which traverses the LSDP array.

In step 736, if needed, the set under test is broken down into further subsets of individual depth pixels. The method then returns to 723.

In 723 the method looks for significant contributions over the set of depth pixels that are pointed to by the addresses contained in the lists. If a set has no significant contribution as determined in 723, the method continues to 726.

In 726 the coordinate indicating the location and X/Y address space is stored in the LISDP array. Next, the number of remaining sets of coefficients is tested. If no more coefficients exist in the set the process continues on to step 740. If more coefficients exist within the sets the process once again returns to step 723. In 723 the sets of coefficients are once again analyzed for significance.

In 740 the method determines if a single significant coefficient has been isolated. In the case where step 740 indicates a significant contribution the method continues to 743.

In 743 again the outpipe for significant contribution is set and the LSDP is updated appropriately.

Returning now to step 740, if a single coefficient does not have a maximum thresholds contribution (i.e. the most significant bit is zero) then the process proceeds to step 746 where the LIDP gets set with the address for next layer evaluation.

In step 750 the method determines if the layer is completed. A layer is completed after all lists of significant and insignificant depth pixels are set where the value of “n” is set to address the appropriate layer number. If the layer is completed, the method continues to step 753 for continuing evaluation of the next most significant layer. In step 753 the layer number is decremented, which in turn lowers the threshold comparison of the first object in question.

In 756 the method determines if additional layers are to be processed. If additional layers remain to be processed, execution returns to 713 and the operation begins again at 713. Again, in 713 of the preferred embodiment the method scales the depth maps to the proper resolution to match the new value of “n”. In alternate embodiments a pre-scaled map may be selected and used for comparison of additional layers.

If in 756 the method determines that there are no additional layers to be processed, i.e., processing for the object has completed, then the value of “n” is now equal to the maximum number of layers minus the number of layers to examine for significant energy. Operation then proceeds to 760.

After the method has completed processing for the object, the process operates to determine the motion vectors which represent block movement of some blocks within the object. The calculation of motion vectors is performed in steps 760 to 799.

In the preferred embodiment, the process of list determination performed in steps 700 through 756 is pipelined with the motion vector calculation steps 760 to 799 in such a way that multiple objects are processed in parallel. For simplification of description of these steps, in the present disclosure these concepts are presented one at a time.

In step 760, the motion vector calculation may first involve motion estimation. In order to perform motion estimation, the maximum thresholds may be examined first, providing hints for later analysis of other less significant layers. The process of motion estimation may involve comparing the lists of significant depth pixels between multiple temporal objects. One novelty of this method is that a block of significant pixels represented by a relative address to such block and the most significant energy signature of the block can be compared rapidly to surrounding blocks of the same format.

After step 760, in 763 significant depth pixel lists and pointers to those layers of lists are initialized.

In 770 the method reads significant lists from the array buffers previously built during steps 700 to 756. The lists of significant pixel addresses in step 770 are formatted for proper comparison to the lists recalled in step 773.

In step 773 the lists of significant pixel addresses were stored at an earlier time during operation of the same object area and depth in what may be considered frame time minus one frame. For example, because the motion vectors are calculated for an individual object, the previous object significant lists are used for differencing operations to the new LSDP. The process than continues to step 776.

In 776 iteration of the significant lists of depth pixels for particular layer determines the best fit. In the present embodiment the best fit is that area of addresses containing a significant energy signature that matches another area from a previous object frame.

In step 780 the method determines the best fit. In one embodiment, the method calculates the sum of absolute differences. The sum of absolute differences is calculated by summation of sub-block areas for each layer independently and comparing these summed values by a taking a difference of the summation of previous layers.

In step 783 a comparison between the sums of absolute differences gives a Best Match scenario.

In step 786 the method determines whether a single block of depth pixels has been completed for particular layer. If the block is not completed, the method returns back to step 776, and steps 776, 780, and 783 are again performed. If in step 786 the block has completed and all layers have not completed, then the process continues to step 763. In 763 a new layer is selected and the process continues from step 770 through step 786.

Although not shown in FIG. 8, the method may use “hints” from the most significant bit iterations for multiple layers for the best-fit best match scenario in step 783. Because the most significant bits are examined first in the highest magnitude threshold layers, the probability of a best-fit match is higher at the onset of the iteration process than in later layers. Hints from higher order layers can tell the Sum of Absolute Difference (SAD) calculations 780 to start the comparison process in the locale where previous SAD values indicate an energy change.

Once all layers have been processed, in 789 the best-fit information is used as an index back to the lists of significant depth pixels containing the addresses of both the reference blocks and the blocks under determination. Blocks 789 and 790 calculate the motion vectors and predictive frames similar to that in prior art techniques.

In 793 motion vector information object pointers are output to the motion vector encoding block 130. At this point, the predictive object and its motion vectors have been calculated, and a network packet is constructed and sent for transport across the transport medium 300 through the packet indicators 285.

In 796 the object lists of prioritized objects is examined. If the method has completed for all objects, operation proceeds to the next video frame. If the process is not completed with all objects as determined in 796, the method returns to 700, and the above operation repeats.

Thus, as described herein, in one embodiment individual objects can be isolated, encoded and sent independently over the transport medium 300. In addition, all objects need not be sent synchronized to the frame rate of the video recorder. In prior art systems objects are assembled into an entire frame, and typically the entire frame is compressed and sent for transport. In one embodiment of the present invention, independent objects may be sent for the transport at different rates based on the priority and bit rate capability of the transport channel.

FIG. 9—Lists of Significant and Insignificant Depth Pixels

FIG. 9 is an example of memory arrays that contain lists of significant and insignificant depth pixels. FIG. 9 illustrates the process of two steps of differencing which occur in steps 770 through step 783 of FIG. 8. As shown in FIG. 9, lists 7330, 7460 and 7260 represent the stored values of an object from a previous frame. In addition, lists 7331, 7461 and 7261 represent the recently calculated values of the new object. The differencing operation compares the old object lists to the new object lists as shown in 7300. Sets of insignificant pixels or isolated insignificant pixels as indicated in 7461 and 7261 respectively are then used to derive a high-resolution list of significant pixels shown in 7341. Once again the motion vector calculation takes the difference 7300 between the information located in the LSDP from the new object 7341 and that of the old stored object 7340. The process would continue by using the lists of insignificant depth pixels 7471 and sets of insignificant depth pixels 7271 to locate the areas of the object map in the next high-resolution map.

One embodiment of the invention operates to isolate multiple objects in area and depth space with an infrared radiation and collection technique. Other embodiments may use different object recognition methods in operating to isolate objects, including face tracking, ultra sound or image resolution detection. One embodiment uses discrete wavelet transforms on individual objects, and operates to capture and/or provide individual objects, and overlay or underlay other objects at independent rates and independent compression ratios to optimize transport requirements. In addition, various embodiments of the present invention teach the benefits of object lists during the determination of object motion over a group of frames. Objects of high-priority or high movement may be sent more frequently to transport than objects of low priority. In one embodiment, background planes are easily replaced with still images or other moving images. Therefore, embodiments of the present invention significantly compensate for transport bit rate and image quality when used for the transport of video imagery across Internet networks.

Although the embodiments above have been described in considerable detail, other versions are possible. Numerous variations and modifications will become apparent to those skilled in the art once the above disclosure is fully appreciated. It is intended that the following claims be interpreted to embrace all such variations and modifications. Note the section headings used herein are for organizational purposes only and are not meant to limit the description provided herein or the claims attached hereto.

We claim:

1. A method for compressing a video sequence, the method comprising:
receiving information regarding images in the video sequence from an image acquisition device;
determining a plurality of objects present in at least one of the images;
determining depth information for each of the plurality of objects;
compressing at least a subset of the objects;
transferring the compressed objects across a transport medium to a receiving device, wherein said transferring comprises transferring objects that have a closer relative depth to the image acquisition device at a greater rate than objects that have a further relative depth to the image acquisition device.

2. The method of claim 1, further comprising:
storing object information associated with each of the objects, wherein, for each object, the object information includes an xy position and the depth value;
wherein said transferring comprises accessing the object information to determine the depth information for one or more of the objects.

3. The method of claim 1,
wherein said transferring comprises transferring a first one or more objects that have a closer relative depth to the image acquisition device at one or more of:
a greater rate; and
a greater resolution; and
wherein said transferring comprises transferring a second one or more objects that have a further relative depth from the image acquisition device at a lesser rate.

4. The method of claim 1,
wherein the first one or more objects are foreground objects, and wherein the second one or more objects are background objects.

5. The method of claim 1,
wherein said compressing comprises compressing objects that have a further relative depth to the image acquisition device with greater compression than objects that have a closer relative depth to the image acquisition device.

6. The method of claim 5,
wherein said compressing comprises compressing objects that have a closer relative depth to the image acquisition device with greater quantization than objects that have a further relative depth to the image acquisition device.

7. The method of claim 1,
further comprising determining motion information for each of the plurality of objects;
wherein said compressing comprises compressing objects that have a lesser amount of motion with greater compression than objects that have a greater amount of motion.

8. The method of claim 1,
wherein said compressing comprises applying a discrete wavelet transform to each of the at least a subset of the objects.

9. The method of claim 1,
wherein said compressing comprises applying a discrete wavelet transform to each of the at least a subset of the objects to produce sub bands for each of the at least a subset of the objects;
wherein said compressing comprises maintaining a greater number of sub bands for objects that have a closer relative depth to the image acquisition device than objects that have a further relative depth to the image acquisition device.

10. The method of claim 1,
wherein the transport medium comprises a network, wherein a bandwidth of the network varies over time.

11. A method for compressing a video sequence, the method comprising:
receiving information regarding images in the video sequence from an image acquisition device;
determining a plurality of objects present in one or more of the images;
determining depth information for each of the plurality of objects;
compressing at least a subset of the objects, wherein said compressing comprises compressing objects that have a further relative depth to the image acquisition device with greater compression than objects that have a closer relative depth to the image acquisition device;
transferring the compressed objects across a transport medium to a receiving device.

12. The method of claim 11
wherein said compressing comprises compressing objects that have a closer relative depth to the image acquisition device with less quantization than objects that have a further relative depth to the image acquisition device.

13. The method of claim 11,
wherein said compressing comprises applying a discrete wavelet transform to each of the at least a subset of the objects.

14. The method of claim 11,
wherein said compressing comprises applying a discrete wavelet transform to each of the at least a subset of the objects to produce sub bands for each of the at least a subset of the objects;
wherein said compressing comprises maintaining a greater number of sub bands for objects that have a closer relative depth to the image acquisition device than objects that have a further relative depth to the image acquisition device.

15. The method of claim 11,
wherein said transferring comprises transferring objects that have a closer relative depth to the image acquisition device at a greater rate than objects that have a further relative depth to the image acquisition device.

16. The method of claim 11, further comprising:
storing object information associated with each of the objects, wherein, for each object, the object information includes an xy position and the depth value;
wherein said transferring comprises accessing the object information to determine the depth value for one or more of the objects.

17. The method of claim 11,
wherein said compressing comprises compressing background objects with greater compression than foreground objects.

18. A method for generating a motion vector representing movement of an object between frames of a video sequence, the method comprising:
receiving information regarding images in the video sequence from an image acquisition device;
for at least a first image in the video sequence,
determining a plurality of objects present in the first image;
generating a first depth image comprising depth information for the first image;
generating motion vectors for one or more objects present in the first image based on said first depth image.

19. The method of claim 18,
wherein said generating motion vectors uses said first depth image from the first image in the video sequence and a depth image from a prior image in the video sequence.

20. The method of claim 18,
wherein said generating motion vectors comprises:
storing first information regarding significant pixels in an object in a prior image based on a depth image of the prior image;
generating second information regarding significant pixels in the object present in the first image based on said first depth image;
comparing the first information and the second information to determine the motion vectors.

21. A method for generating a motion vector representing movement of an object between frames of a video sequence, the method comprising:
receiving information regarding images in the video sequence from an image acquisition device;
determining a plurality of objects present in one or more of the images;
for an object in a first frame,
examining a first resolution map of the object to determine significant and insignificant pixels in the first resolution map; and
examining one or more higher resolution maps of the object to determine significant and insignificant pixels based on said examination in the first resolution map;
creating an address list indicating locations of significant pixels in the object for the first frame;
comparing the address list created for the object for the first frame with an object list created for the object in a prior frame; and
generating at least one motion vector for the object indicating movement of the object from the prior frame to the first frame.

22. The method of claim 21,
wherein said generating comprises generating a plurality of motion vectors, wherein each of the motion vectors represents movement of a sub-block in the object.

23. The method of claim 21,
wherein the address list also indicates locations of significant pixels in the object for the first frame.
